(19) United States
(12) Patent Application Publication
(10) Pub. No.: US 2014/0094989 A1
(43) Pub. Date: Apr. 3, 2014

(54) MECHANISM FOR FACILITATING REAL-TIME CONTEXT-AWARE MESSAGES FOR VEHICLE-BASED AND OTHER COMPUTING DEVICES

(71) Applicants: SAURABH DADU, Tigard, OR (US); Gyan Prakash, Beaverton, OR (US); Rajesh Poornachandran, Portland, OR (US); Ravikiran Chukka, Beaverton, OR (US)

(72) Inventors: SAURABH DADU, Tigard, OR (US); Gyan Prakash, Beaverton, OR (US); Rajesh Poornachandran, Portland, OR (US); Ravikiran Chukka, Beaverton, OR (US)

(21) Appl. No.: 13/629,969

(22) Filed: Sep. 28, 2012

(51) Int. Cl. B60Q 1/00; G08G 1/0967; G06F 17/00

(52) U.S. Cl. 701/1; 340/438; 340/905

(57) ABSTRACT

A mechanism is described for facilitating real-time context-aware messages at computing devices according to one embodiment. A method of embodiments, as described herein, includes evaluating real-time context-aware data relating to a vehicle, recommending a real-time message based the evaluation of the context-aware data. The recommended message may include one or more of a warning message, an alert message, a reminder message, and an information message. The method may further include facilitating displaying the recommended real-time message at a first display screen at the vehicle or a second display screen of a mobile computing device within a proximity of the vehicle. Other embodiments are described and claimed.

### FIELD

Embodiments, as described herein, relate to messaging systems. More particularly, embodiments relate to a mechanism for facilitating real-time context-aware messages for vehicle-based and other computing devices.

### BACKGROUND

Even with increasing traffic and technologically-advanced vehicles, conventional techniques to provide messages regarding various conditions (e.g., traffic conditions) in vehicles are unintelligent and limited in their approach as most messages are wasted due to being imprecise and delayed in terms of their content and delivery time, respectively.

### BRIEF DESCRIPTION OF THE DRAWINGS

Embodiments, as described here, are illustrated by way of example, and not by way of limitation, in the figures of the accompanying drawings in which like reference numerals refer to similar elements.

FIG. 1 illustrates a real-time context-aware message delivery mechanism employed at a computing device according to one embodiment.

FIG. 2 illustrates a real-time context-aware message delivery mechanism and a vehicle-based message placement mechanism according to one embodiment.

FIG. 3 illustrates a method for facilitating real-time context-aware messages at computing devices according to one embodiment.

FIG. 4 illustrates computer system suitable for implementing embodiments of the present disclosure according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments facilitate delivery of messages at vehicles such that the messages are context-aware (e.g., a message warning the driver of an upcoming pothole or an accident, etc.) and displayed in real-time. In one embodiments, context-aware messages are specific to any number and type of factors including, but not limited to, condition of the vehicle (e.g., low on gas, need new brakes, etc.), location or planned route (as determined using a navigation system) of the vehicle (e.g., near an amusement park, near a grocery store, stuck in traffic on a freeway, a particular city or town, etc.), natural/environmental conditions (e.g., rain, snow, fog, etc.), road/traffic conditions (e.g., potholes, closed lanes, construction projects, accidents, etc.), condition/activity of expected listeners (e.g., lunch time, driving record, history of accidents and/or citations, driving limitations (e.g., young driver, low eyesight, the driver and/or the passengers might be interested in a nearby parking lot or restaurant, etc.), vehicle condition (e.g., 4-wheel drive, performance in heavy snow, off-road clearance, etc.), or the like.

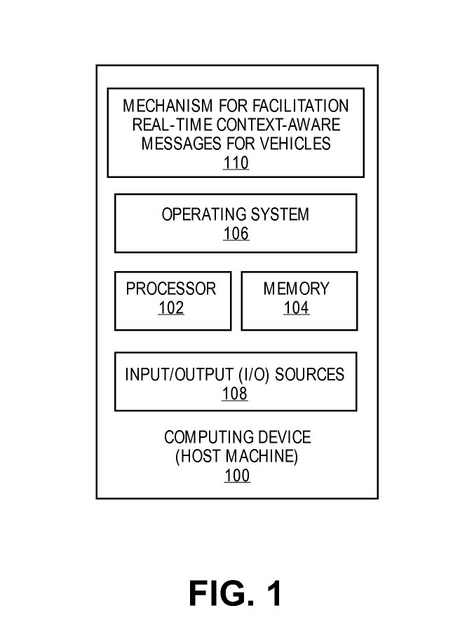

FIG. 1 illustrates a real-time context-aware message delivery mechanism 110 employed at a computing device 100 according to one embodiment. Computing device 100 serves as a host machine to employ real-time context-aware message delivery mechanism (“message delivery mechanism”) 110 to facilitate delivery of real-time context-aware messages for vehicles (e.g., any motorcycle or automobiles having a computer-based display screen, such as cars, trucks, sports utility vehicles (SUV), etc.). In one embodiment, these messages may include information messages (e.g., distance remaining, such as “25 miles or 30 minutes to destination”, etc.), warnings (e.g., “rain or snow ahead”, “slippery road ahead”) or alerts (e.g., nearing a problem, such as “pothole 100 feet away”, and the like.

Computing device 100 may include mobile computing devices, such as cellular phones including smartphones (e.g., iPhone® by Apple®, BlackBerry® by Research in Motion®, etc.), personal digital assistants (PDAs), etc., tablet computers (e.g., iPad® by Apple®, Galaxy 3® by Samsung®, etc.), laptop computers (e.g., notebooks, netbooks, ultrabooks™, etc.), e-readers (e.g., Kindle® by Amazon.com®, Nook® by Barnes and Nobles®, etc.), etc. Computing device 100 may further include set-top boxes (e.g., Internet-based cable television set-top boxes, etc.), and larger computing devices, such as desktop computers, server computers, etc.

Computing device 100 includes an operating system (OS) 106 serving as an interface between any hardware or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc. It is to be noted that terms like “computing device”, “node”, “computing node”, “client”, “host”, “server”, “memory server”, “machine”, “device”, “computing device”, “computer”, “computing system”, and the like, may be used interchangeably throughout this document.

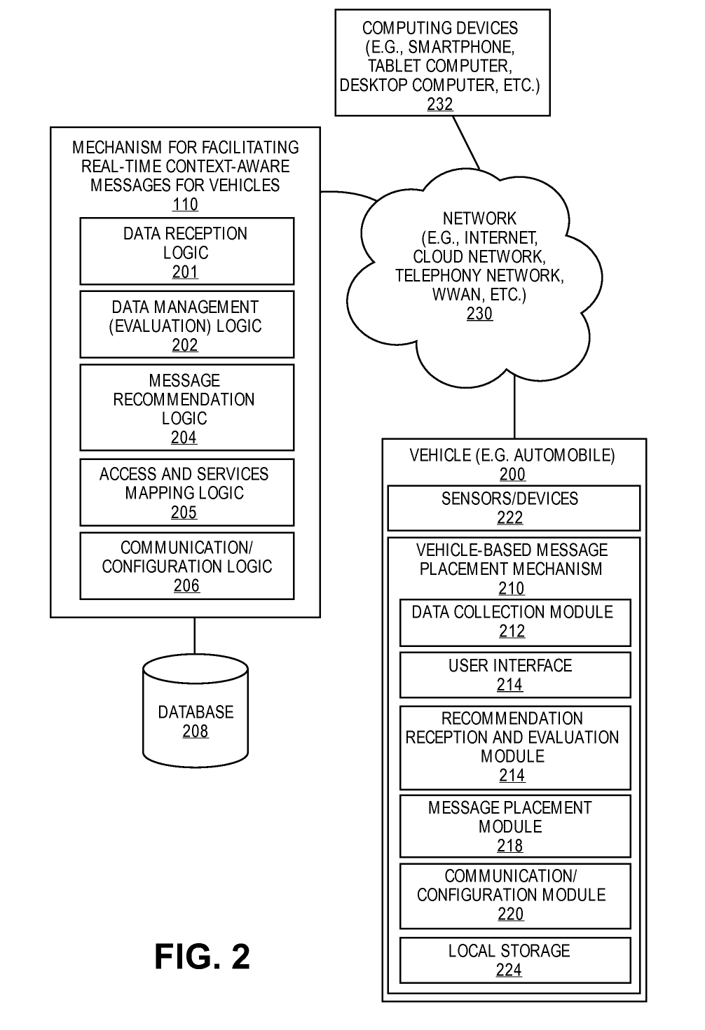

FIG. 2 illustrates a real-time context-aware message delivery mechanism 110 and a vehicle-based message placement mechanism 210 according to one embodiment. In one embodiment, message delivery mechanism 110 includes a number of components, such as data reception logic 201, data management (evaluation) logic 202, message recommendation logic 204, and communication/configuration logic 206, and is in communication with database 208. Similarly, vehicle-based message placement mechanism (“message placement mechanism”) 210 includes a number of components, such as data collection module 212, user interface 214, recommendation reception and evaluation module 216, message placement module 218, communication/compatibility module 220, local storage 224, and remains in communication with any number and type of sensors and other devices (collectively referred to as “sensors”) 222. In one embodiment, message delivery mechanism 110 may be a server-based mechanism hosted by a server computer (e.g., computing device 100 of FIG. 1), while message placement mechanism 210 may be employed at an onboard computer of vehicle 200 and/or at any one or more of computing devices 232. Throughout this document, the term “logic” may be interchangeably referred to as “component” or “module” and may include, by way of example, software, hardware, and/or any combination of software and hardware, such as firmware.

In one embodiment, messages may be displayed on a display screen within a vehicle, such as vehicle 200, where the display screen may in communication with a computing device, such as an onboard computer, a global positioning system (GPS)/navigation system, etc. It is contemplated that embodiments are not limited to simply vehicle-based display screen and/or computing device and that for example and in one embodiment, in addition to or in lieu of displaying the messages at a vehicle-based display screen, these messages may be displayed on one or more computing devices 232, such as a mobile computing device (e.g., a smartphone, a tablet computer, a laptop computer, etc.) or a desktop computing device, etc., belonging to a user (e.g., an owner of the vehicle, a driver or a passenger of the vehicle, etc.), or the like. Furthermore, the user may use computing devices 232 to create profile, change settings, etc., relating to message delivery mechanism 110.

Vehicle 200 may have sensors 222 (e.g., GPS, navigation system, a brake sensor, a rain sensor, a fuel sensor, a temperature sensor, an oxygen sensor, a proximity sensor, a compass, a speedometer or a speed sensor, a yaw rate sensor, an accelerometer, a steering wheel positioning center to reveal driver's intention, a clock, a traction control systems, an anti-lock brake system (ABS), an electronic stability control (ESC), an on-board diagnostics (OBD) tool, a forward-facing camera, a rear-facing camera, etc.) to detect real-time data about the vehicle 200 and the surrounding environment. Vehicle 200 may employ or recognize other devices (e.g., Bluetooth-pair devices, such as smartphones) to provide a real-time current status of vehicle 200, its location, and identification and preferences of persons in vehicle 200, etc.

Vehicle 200 may also have an on-board computer or embedded computer, such as electronic control unit (ECU), to process any results obtained from those sensors 222 to contribute towards better performance of the vehicle 200. For example, data obtained by sensors 222 may be fed into the ECU at vehicle 200 which may in turn run control algorithms on the data to find out whether vehicle 200 is losing control or stability, etc. In one embodiment, message placement mechanism 210 may be employed as a software application at the ECU of vehicle 200 and be in communication with sensors 222. For example and in one embodiment, data collection module 212 communicates with sensors 222 to collect data sensed and obtained by one or more of sensors 222. For example, a GPS/navigation system of vehicle 200 may provide location data relating to exact geographic location of vehicle and this data may then be used to provide messages regarding, for example, road/traffic conditions within certain parameter of the area and/or depending on the travel direction of vehicle 200 (e.g., a traffic accident down the road may be regarded as more important than a past traffic accident, etc.).

In another embodiment, various data (e.g., road or traffic conditions, weather news, etc.) may be provided or inputted by users through one or more computing devices 232 and may then be collected by data collection module 212 of message placement mechanism 210 and/or directly received at data reception logic 201 at message delivery mechanism 110 over network 230 (e.g., the Internet, cloud network, telephony network, mobile or wireless wide area network (WWAN), such as 3^{rd} Generation (3G), long term evaluation (LTE), etc.). In one embodiment, data collected or aggregated by data collection module 212 may be provided to message delivery mechanism 110 and received by its data reception logic 201. Data reception logic 201 provide the received data to data management (evaluation) logic 202 for analysis and evaluation to determine whether the received data is deserving of a message and if yes, what content it is ought to carry and display.

Data management (evaluation) logic 202 may evaluate the received data (including data received from computing devices 232 and/or from message placement mechanism 210). The evaluated data is then provided to message recommendation logic 204 to recommend a message based on the evaluated data. For example, the incoming crowd/user data from computing device 232 may have indicated a rather large pothole at a particular location on the road. The incoming user data received at data reception logic 201 may have been a result of a number of users calling, texting and/or emailing, using their computing devices 232 (e.g., smartphones, tablet computers, desktops, etc.), regarding the pothole. In one embodiment, each computing device 232 may employ a mechanism, similar to or the same as message placement mechanism 210, that provides a user interface, similar to or the same as user interface 214, to be used by the users for inputting data (e.g., context data, personal data, vehicle data, data relating to user preferences and settings, etc.). Similarly, for example, a GPS sensor (e.g., navigation system) of sensors 222 at vehicle reports the exact physical location of vehicle 200. This location data may be collected by data collection module 212 and provided to data reception logic 201 which then forwards the location data to data management (evaluation) logic 202 where it is evaluated in light of the user data received from computing devices 232. Further, for example, an accelerometer of sensors 222 may be used to detect the pothole and provide it to data collection module 212.

In one embodiment, data collected by sensors/devices 222 at vehicle 200 may be aggregated and a report (e.g., a report providing information relating to road/weather/traffic conditions, etc.) to a server computer, such as a server computer employing message delivery mechanism 110 or one or more other server computers over network 230, such as a cloud network, without any user interaction. For example, the computer server may receive data or reports from any number of vehicles, such as vehicle 200, and run statistics using data management (evaluation) logic 202 to determine, for example, the authenticity of any information provided in the reports, such as whether the reported pothole really exists. It is contemplated the report of an incident or problem, such as a pothole down the road, might not be regarded as significant if reported by, for example, a single vehicle for a combination of reasons, such as (1) the accelerometer of the vehicle may have been defective, (2) a tire of the vehicle may have punctured causing the accelerometer to produce false alarm, and/or (3) there may be a minor accident causing the false alarm, etc. However, in one embodiment, if there are multiple vehicles (meeting a predetermined number/threshold) detecting and reporting the same pothole, then data management (evaluation) logic 202 may provide better statistics regarding the pothole, such as a higher probability of the existence of the pothole. Similarly, other events, problems, obstacles, etc., may be calculated by data management (evaluation) logic 202, such as if multiple vehicle are reporting loss of traction at the same spot on the road, the road may be evaluated and regarded as slippery by data management (evaluation) logic 202.

In some embodiments, once the data is evaluated and processed by data management (evaluation) logic 202, it may then be provided to users for their access and review. In one embodiment, access and services mapping logic 205 may facilitate access and mapping of the processed data to users over network 230, such as a cloud network, such that the users may access the processed data via one or more computing devices 232. For example, a user may access the processed data via a website and/or map any of the processed data through a service website, such as Google® maps, to review traffic/weather conditions on a certain route and/or within a particular region before deciding on a journey, such as whether to take the journey, what mode of transportation to take (e.g., private, public, neither and choose to walk, etc.), and the like. Further, as will be referenced below, certain professionals and agencies, such as government agencies, meteorologists, etc., may use the same information to perform certain tasks, such as fix roads, issue weather warnings, etc.

Further, in one embodiment, other relevant data may be obtained by from database 208. For example, continuing with the example, data management (evaluation) logic 202 may access database 208 to search for any relevant data about vehicle 200, such type, make, model, weight, etc., to determine whether vehicle 200 can withstand the impact of the reported pothole. In putting these sets of data together and upon evaluation, data management logic 202 may determine that vehicle 200 is a short distance away (e.g., a mile away) and on its way to possibly encounter the pothole and that a warning message ought to be generated and delivered to vehicle 200.

In one embodiment, data management logic 202 may provide the results of the evaluation to message recommendation logic 204. At message recommendation logic 204, a relevant message (e.g., “warning a large pothole about a mile ahead”, etc.) may be generated. As noted above, other relevant data obtained from database 208 may be taken into consideration. For example, if vehicle 200 is a sports utility vehicle (SUV) and a four-wheel drive (4WD), a soft message, such as “note a large pothole about a mile ahead”, might be sufficient. In contrast, if vehicle 200 is a small car and/or a motorcycle, or the like, a tougher message, such as “WARNING—a large pothole about a MILE ahead”, etc., might be displayed (even flashed, colored, etc.) and, depending on the circumstances and user profile settings, a detour might also be suggested. An appropriate message may be recommended by message recommendation logic 204 and communicated, via communication/configuration logic 206, over to recommendation reception and evaluation module 216, via communication/configuration module 220, at message placement mechanism 210.

At message placement mechanism 210, in one embodiment, recommendation reception and evaluation module 216 performs a quick evaluation of the recommended message, such as using any relevant information (e.g., context data, user preferences, a recent event or condition detected by one of the sensors 222, etc.) stored at local storage 224, to make a final determination as to whether the recommendation message by displayed. If the recommended message is not to be displayed, it may be discarded. However, if the recommended message is to be displayed, it is provided to message placement module 218 which facilitates displaying of the recommended message on a display screen at vehicle 200 for the benefit of the driver and/or any passengers. For example, the message may be displayed on a navigation system screen, flashed across a radio screen, showed on a dedicated display screen, such as an onboard computer screen, etc.

Other examples of data sensing, data aggregation, message recommendation, data use, etc., may include, but are not limited to, (1) the ESC may detect road conditions (e.g., how slippery is the road, etc.), (2) one or more weather sensors (e.g., a temperature sensor, a rain sensor, etc.) may detect fine-grained weather conditions, such as whether it is raining within a radius of 5 feet of a particular location, the exact outside temperature, etc., (3) a speed detector may detect the exact speed of vehicle 200 and provide speed-related data, such as reduced speed ahead, etc., and (4) data stored at database 208 and/or local storage 224 may be used to determine historical data and/or patterns relating to drivers, passengers, vehicles, physical locations, highways, etc., and then further used for recommending an appropriate message. For example, information like a driver known for driving fast or slamming on brakes at turns, etc., obtained from database 208 and/or local storage 224 may be used to justify displaying a stronger warning, such as regarding a slippery road, etc. Further, any combination of sensed data, stored data, and/or crowd/user-sourced data (including user feedbacks, comments, etc.) may be used not only for the purposes of recommending appropriate messages, but also used for performing fine-tuning or safety-check of vehicles, building better future vehicles, building new or fix existing roads, changing speed limits in certain areas, etc. For example, reports of cracks/potholes on a particular patch of a road and/or a number of accidents at a particular roundabout may lead relevant government agencies to review, such as via a website, the processed data or information as facilitated by the aforementioned access and services mapping logic 205 and consequently, dispatch teams to fix the reported cracks/potholes and/or lower the posted speed at the roundabout, respectively.

Communication/configuration logic 206 and communication/configuration module 220 may facilitate an ability for message delivery and placement mechanisms 110, 210 to remain compatible with and be able to communicate with any number and type of sensors, devices, systems, vehicles, radio and/or broadcast stations, computing devices (e.g., mobile computing devices (such as various types of smartphones, tablet computers), websites, (such as social networking websites (e.g., Facebook®, LinkedIn®, Google+®, etc.)), networks, etc.), while ensuring future compatibility and communication with changing technologies, parameters, protocols, standards, etc.

It is contemplated that any number and type of components may be added to and/or removed from message delivery mechanism 110 and/or message placement mechanism 210 to facilitate various embodiments including adding, removing, and/or enhancing certain features. For brevity, clarity, and ease of understanding of the message delivery and placement mechanisms 110, 210 many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

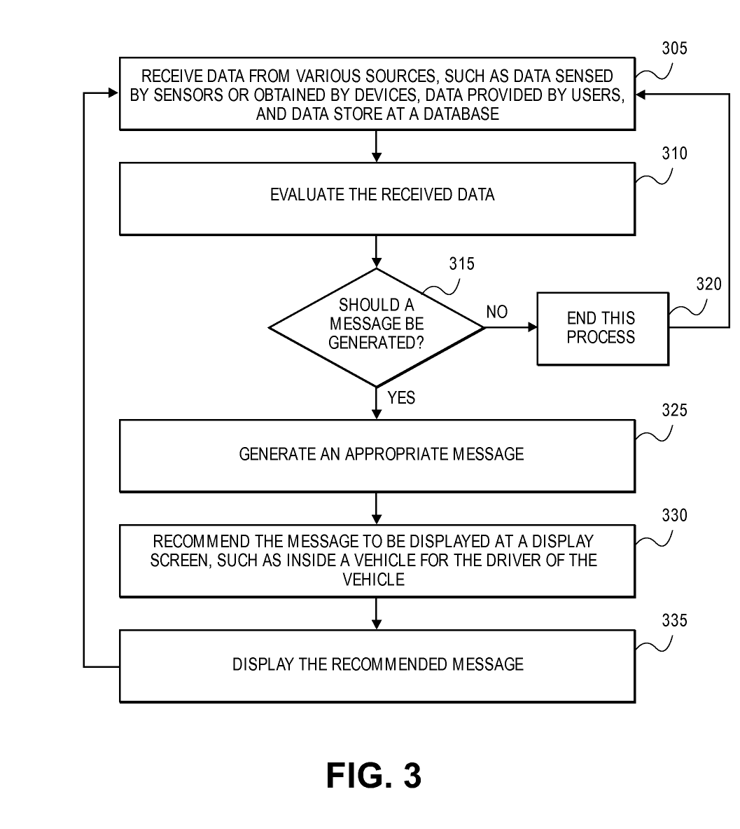

FIG. 3 illustrates a method for facilitating real-time context-aware messages at computing devices according to one embodiment. Method 300 may be performed by processing logic that may comprise hardware (e.g., circuitry, dedicated logic, programmable logic, etc.), software (such as instructions run on a processing device), or a combination thereof. In one embodiment, method 300 may be performed by message delivery mechanism 110 of FIG. 1 and/or message placement mechanism 210 of FIG. 2.

Method 300 begins at block 305 with receiving data (e.g., context data) from various data sources, such as user data provided by one or more users using one or more computing devices, sensor data provided by various sensors and/or devices, such as at a vehicle, and stored data at a database, and the like. At block 310, the received data is evaluated in light of data received from difference sources taking into consideration any continuing real-time changes (such as a weather condition, road condition, etc.) to consider whether the evaluated data is worthy of generating a message for a user, such the driver of the vehicle. At block 315, a determination is made as to whether, in light of the evaluated data, a message be generated. At block 320, if no message is to be generated, the ongoing processed based on the received/evaluated data is terminated, while some of the received data is discarded and, in some embodiments, some of the received data (e.g., driver's input, such as tire type, service date, etc.) may be stored at the database for subsequent uses. The process may return to receiving new data at block 305.

Referring back to block 315, if the message is to be generated, an appropriate message is generated at block 325. As discussed above, the message may include, but is not limited to, a warning, an alert, a reminder, an information, etc. At block 330, the generated message is recommended to be displayed on a display screen, such as at an onboard computer and/or a navigation system display screen of the vehicle and/or at another computing device, such as at a mobile device (e.g., a smartphone, a tablet computer, etc.) of the driver and/or a passenger of the vehicle. As provided by the user (such as through user preferences, user settings, etc.), the recommended message may be simultaneously displayed at two or more display screens (of two or more computing devices) or at a single display screen, such as the one provided inside the vehicle (e.g., navigation system screen, onboard ECU/computer screen, radio display, etc.). At block 335, the recommended message is displayed.

In one embodiment, various processes, such as evaluation of the received data (block 310), determination of whether one or more message be generated (block 315), recommendation for message display (block 330), including selection of an appropriate display device, etc., may be performed using one or algorithms and one or more components of message delivery mechanism 110 (residing at a cloud server computer) and/or message placement mechanism 210 (residing at an ECU of a vehicle) of FIG. 2. For example, message delivery mechanism 110 may be employed at a cloud server computing system, such as host machine 100, where it uses its components to receive data from various aforementioned sources (e.g., sensor devices, etc.), aggregate the received data, and perform data mining of the aggregated data to determine, for example, road conditions. Further, message delivery mechanism 100 accounts for an error margin by correlating crowd-sourced data with other data that is received from statically and strategically deployed sources and any relevant feedback (such as the data mining process may be tuned so it is based on the feedback). Then, one or more messages may generated and one or more appropriate notifications/alerts may be sent to users at an appropriate display device, such as the vehicle's ECU display screen or a display screen of a mobile computing device (e.g., smartphone, tablet computer) that is within a proximity of the vehicle.

In some embodiments, the recommended message may not be delivered as recommended if another real-time situation arises capable of making the recommended message irrelevant (e.g., a sudden turn by the vehicle that can make a road accident ahead irrelevant, etc.). In this case, various actions may be facilitated, such as discarding the recommended message (e.g., when the vehicle makes a sudden turn, making the recommended message irrelevant, etc.), putting the recommended message on hold to be displayed later (e.g., when the vehicle stops for a while or takes a detour, etc.), displaying an edited message (e.g., such as a status update relating to a previously-displayed warning has arrived, etc.), etc.

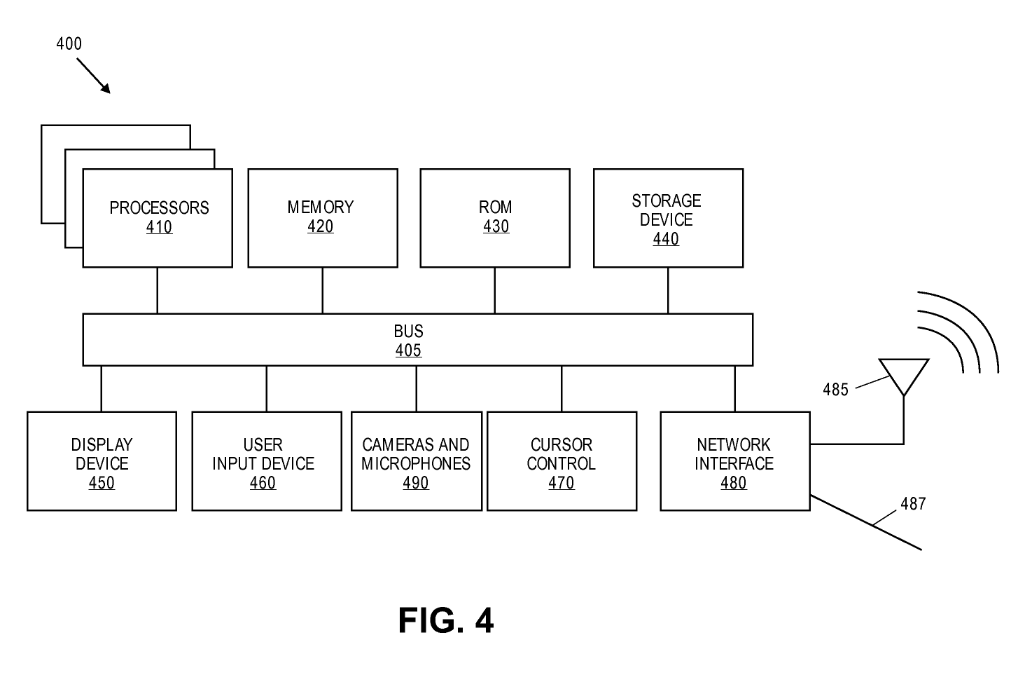

FIG. 4 illustrates an embodiment of a computing system 400. Computing system 400 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, etc. Alternate computing systems may include more, fewer and/or different components.

Computing system 400 includes bus 405 (or a link, an interconnect, or another type of communication device or interface to communicate information) and processor 410 coupled to bus 405 that may process information. While computing system 400 is illustrated with a single processor, electronic system 400 and may include multiple processors and/or co-processors, such as one or more of central processors, graphics processors, and physics processors, etc. Computing system 400 may further include random access memory (RAM) or other dynamic storage device 420 (referred to as main memory), coupled to bus 405 and may store information and instructions that may be executed by processor 410. Main memory 420 may also be used to store temporary variables or other intermediate information during execution of instructions by processor 410.

Computing system 400 may also include read only memory (ROM) and/or other storage device 430 coupled to bus 405 that may store static information and instructions for processor 410. Date storage device 440 may be coupled to bus 405 to store information and instructions. Date storage device 440, such as magnetic disk or optical disc and corresponding drive may be coupled to computing system 400.

Computing system 400 may also be coupled via bus 405 to display device 450, such as a cathode ray tube (CRT), liquid crystal display (LCD) or Organic Light Emitting Diode (OLED) array, to display information to a user. User input device 460, including alphanumeric and other keys, may be coupled to bus 405 to communicate information and command selections to processor 410. Another type of user input device 460 is cursor control 470, such as a mouse, a trackball, or cursor direction keys to communicate direction information and command selections to processor 410 and to control cursor movement on display 450. Camera and microphone arrays 490 of computer system 400 may be coupled to bus 405 to observe gestures, record audio and video and to receive and transmit visual and audio commands.

Computing system 400 may further include network interface(s) 480 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 480 may include, for example, a wireless network interface having antenna 485, which may represent one or more antenna(e). Network interface(s) 480 may also include, for example, a wired network interface to communicate with remote devices via network cable 487, which may be, for example, an Ethernet cable, a coaxial cable, a fiber optic cable, a serial cable, or a parallel cable.

Network interface(s) 480 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 480 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 480 may including one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 400 may vary from implementation to implementation depending upon numerous factors, such as price constraints, performance requirements, technological improvements, or other circumstances. Examples of the electronic device or computer system 400 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments, as described here. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following clauses and/or examples pertain to further embodiments or examples. Specifics in the examples may be used anywhere in one or more embodiments. The various features of the different embodiments or examples may be variously combined with some features included and others excluded to suit a variety of different applications. Some embodiments pertain to a method comprising: evaluating real-time context-aware data relating to a vehicle; recommending a real-time message based the evaluation of the context-aware data, wherein the recommended message includes one or more of a warning message, an alert message, a reminder message, and an information message; and facilitating displaying the recommended real-time message at a first display screen at the vehicle or a second display screen of a mobile computing device within a proximity of the vehicle.

Embodiments or examples include any of the above methods further comprising receiving the real-time context-aware data from at least one of one or more sensors or devices of the vehicle, one or more computing devices in communication with the vehicle, or one or more databases.

Embodiments or examples include any of the above methods further comprising access and mapping logic to facilitate providing access to and mapping of the evaluated real-time context-aware data over a network.

Embodiments or examples include any of the above methods wherein the real-time context-aware data comprises real-time context information relating to the vehicle, surrounding environment, and one or more individuals associated with the vehicle, wherein the one or more individuals include an owner of the vehicle, a driver of the vehicle, or one or more passengers of the vehicle, wherein the surrounding environment includes one or more of a road condition, a traffic condition, and a weather condition.

Embodiments or examples include any of the above methods wherein the one or more sensors comprise one or more of a global positioning system (GPS) device, a brake sensor, a rain sensor, a fuel sensor, a temperature sensor, an oxygen sensor, a parking sensor, a compass, a speedometer, a speed sensor, a yaw rate sensor, an accelerometer, a steering wheel positioning center, a clock, a traction control system, an anti-lock brake system (ABS), an electronic stability control (ESC), an on-board diagnostics (OBD) tool, and a Bluetooth pairing device.

Embodiments or examples include any of the above methods wherein the first display screen is associated with a display device coupled to an onboard computer of the vehicle or a navigation system associated with the vehicle, wherein the onboard computer includes an electronic control unit (ECU).

Embodiments or examples include any of the above methods wherein the recommended real-time message is displayed at a second display screen, wherein the second display screen is associated with a display device coupled to a computing device including a mobile computing device.

Embodiments or examples include any of the above methods further comprising: data collection module to collect the real-time context-aware data received from the one or more sensors at the vehicle; recommendation reception and evaluation module to recommend whether the real-time message be displayed at one of the first display screen or the second display screen; and message placement module to display the message at one of the first display screen or the second display screen.

Embodiments or examples include any of the above methods further comprising: a user interface to provide user access, wherein the user interface is provided via one of the onboard computer of the vehicle or the mobile computing device within the proximity of the vehicle; and a local storage of the onboard computer.

Another embodiment or example includes an apparatus performing any of the methods in the examples above.

In another embodiment or example, an apparatus comprises: data management logic to evaluate real-time context-aware data relating to a vehicle; message recommendation logic to recommend a real-time message based the evaluation of the context-aware data, wherein the recommended message includes one or more of a warning message, an alert message, a reminder message, and an information message; and message placement logic to facilitate displaying the recommended real-time message at a first display screen at the vehicle or a second display screen of a mobile computing device within a proximity of the vehicle.

Embodiments or examples include the apparatus above further comprising data reception logic to receive the real-time context-aware data from at least one of one or more sensors or devices of the vehicle, one or more computing devices in communication with the vehicle, or one or more databases.

Embodiments or examples include the apparatus above further comprising access and mapping logic to facilitate providing access to and mapping of the evaluated real-time context-aware data over a network.

Embodiments or examples include the apparatus above wherein the real-time context-aware data comprises real-time context information relating to the vehicle, surrounding environment, and one or more individuals associated with the vehicle, wherein the one or more individuals include an owner of the vehicle, a driver of the vehicle, or one or more passengers of the vehicle, wherein the surrounding environment includes one or more of a road condition, a traffic condition, and a weather condition.

Embodiments or examples include the apparatus above wherein the one or more sensors comprise one or more of a global positioning system (GPS) device, a brake sensor, a rain sensor, a fuel sensor, a temperature sensor, an oxygen sensor, a parking sensor, a compass, a speedometer, a speed sensor, a yaw rate sensor, an accelerometer, a steering wheel positioning center, a clock, a traction control system, an anti-lock brake system (ABS), an electronic stability control (ESC), an on-board diagnostics (OBD) tool, and a Bluetooth pairing device.

Embodiments or examples include the apparatus above wherein the first display screen is associated with a display device coupled to an onboard computer of the vehicle or a navigation system associated with the vehicle, wherein the onboard computer includes an electronic control unit (ECU).

Embodiments or examples include the apparatus above wherein the recommended real-time message is displayed at a second display screen, wherein the second display screen is associated with a display device coupled to a computing device including a mobile computing device.

Embodiments or examples include the apparatus above further comprising: data collection module to collect the real-time context-aware data received from the one or more sensors at the vehicle; recommendation reception and evaluation module to recommend whether the real-time message be displayed at one of the first display screen or the second display screen; and message placement module to display the message at one of the first display screen or the second display screen.

Embodiments or examples include the apparatus above further comprising: a user interface to provide user access, wherein the user interface is provided via one of the onboard computer of the vehicle or the mobile computing device within the proximity of the vehicle; and a local storage of the onboard computer.

In another embodiment or example, a system comprises: a computing device having a memory to store instructions, and a processing device to execute the instructions, the computing device further having a mechanism to: evaluate, via data management logic, real-time context-aware data relating to a vehicle; recommend, via message recommendation logic, a real-time message based the evaluation of the context-aware data, wherein the recommended message includes one or more of a warning message, an alert message, a reminder message, and an information message; and facilitate, via message placement logic, displaying the recommended real-time message at a first display screen at the vehicle or a second display screen of a mobile computing device within a proximity of the vehicle.

Embodiments or examples include the system above wherein the mechanism is further to receive, via data reception logic, the real-time context-aware data from at least one of one or more sensors or devices of the vehicle, one or more computing devices in communication with the vehicle, or one or more databases.

Embodiments or examples include the system above wherein the mechanism is further to facilitate providing access to and mapping of the evaluated real-time context-aware data over a network.

Embodiments or examples include the system above wherein the real-time context-aware data comprises real-time context information relating to the vehicle, surrounding environment, and one or more individuals associated with the vehicle, wherein the one or more individuals include an owner of the vehicle, a driver of the vehicle, or one or more passengers of the vehicle, wherein the surrounding environment includes one or more of a road condition, a traffic condition, and a weather condition.

Embodiments or examples include the system above wherein the one or more sensors comprise one or more of a global positioning system (GPS) device, a brake sensor, a rain sensor, a fuel sensor, a temperature sensor, an oxygen sensor, a parking sensor, a compass, a speedometer, a speed sensor, a yaw rate sensor, an accelerometer, a steering wheel positioning center, a clock, a traction control system, an anti-lock brake system (ABS), an electronic stability control (ESC), an on-board diagnostics (OBD) tool, and a Bluetooth pairing device.

Embodiments or examples include the system above wherein the first display screen is associated with a display device coupled to an onboard computer of the vehicle or a navigation system associated with the vehicle, wherein the onboard computer includes an electronic control unit (ECU).

Embodiments or examples include the system above wherein the recommended real-time message is displayed at a second display screen, wherein the second display screen is associated with a display device coupled to a computing device including a mobile computing device.

Embodiments or examples include the system above further comprising: data collection module to collect the real-time context-aware data received from the one or more sensors at the vehicle; recommendation reception and evaluation module to recommend whether the real-time message be displayed at one of the first display screen or the second display screen; and message placement module to display the message at one of the first display screen or the second display screen.

Embodiments or examples include the system above further comprising: a user interface to provide user access, wherein the user interface is provided via one of the onboard computer of the vehicle or the mobile computing device within the proximity of the vehicle; and a local storage of the onboard computer.

In another embodiment or example, an apparatus comprises means for performing any one or more of the operations mentioned above.

In yet another embodiment or example, at least one machine-readable storage medium comprising a plurality of instructions that in response to being executed on a computing device, causes the computing device to carry out a method according to any one or more of the operations mentioned above.

In yet another embodiment or example, at least one non-transitory or tangible machine-readable storage medium comprising a plurality of instructions that in response to being executed on a computing device, causes the computing device to carry out a method according to any one or more of the operations mentioned above.

In yet another embodiment or example, a computing device arranged to perform a method according to any one or more of the operations mentioned above.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
data management logic to evaluate real-time context-aware data relating to a vehicle;
message recommendation logic to recommend a real-time message based on the evaluation of the context-aware data, wherein the recommended message includes one or more of a warning message, an alert message, a reminder message, and an information message; and
message placement logic to facilitate displaying the recommended real-time message at a first display screen at the vehicle or a second display screen of a mobile computing device within a proximity of the vehicle.

2. The apparatus of claim 1, further comprising data reception logic to receive the real-time context-aware data from at least one of one or more sensors or devices of the vehicle, one or more computing devices in communication with the vehicle, or one or more databases.

3. The apparatus of claim 1, further comprising access and mapping logic to facilitate providing access to and mapping of the evaluated real-time context-aware data over a network.

4. The apparatus of claim 1, wherein the real-time context-aware data comprises real-time context information relating to the vehicle, surrounding environment, and one or more individuals associated with the vehicle, wherein the one or more individuals include an owner of the vehicle, a driver of the vehicle, or one or more passengers of the vehicle, wherein the surrounding environment includes one or more of a road condition, a traffic condition, and a weather condition.

5. The apparatus of claim 2, wherein the one or more sensors comprise one or more of a global positioning system (GPS) device, a brake sensor, a rain sensor, a fuel sensor, a temperature sensor, an oxygen sensor, a parking sensor, a compass, a speedometer, a speed sensor, a yaw rate sensor, an accelerometer, a steering wheel positioning center, a clock, a traction control system, an anti-lock brake system (ABS), an electronic stability control (ESC), an on-board diagnostics (OBD) tool, and a Bluetooth pairing device.

6. The apparatus of claim 1, wherein the first display screen is associated with a display device coupled to an onboard computer of the vehicle or a navigation system associated with the vehicle, wherein the onboard computer includes an electronic control unit (ECU).

7. The apparatus of claim 1, further comprising:
data collection module to collect the real-time context-aware data received from the one or more sensors at the vehicle;
recommendation reception and evaluation module to recommend whether the real-time message be displayed at one of the first display screen or the second display screen; and
message placement module to display the message at one of the first display screen or the second display screen.

8. The apparatus of claim 7, further comprising:
a user interface to provide user access, wherein the user interface is provided via one of the onboard computer of the vehicle or the mobile computing device within the proximity of the vehicle; and
a local storage of the onboard computer.

9. A computer implemented method comprising:
evaluating real-time context-aware data relating to a vehicle;
recommending a real-time message based on the evaluation of the context-aware data, wherein the recommended message includes one or more of a warning message, an alert message, a reminder message, and an information message; and
facilitating displaying the recommended real-time message at a first display screen at the vehicle or a second display screen of a mobile computing device within a proximity of the vehicle.

10. The method of claim 15, further comprising receiving the real-time context-aware data from at least one of one or more sensors or devices of the vehicle, one or more computing devices in communication with the vehicle, or one or more databases.

11. The method of claim 15, further comprising access and mapping logic to facilitate providing access to and mapping of the evaluated real-time context-aware data over a network.

12. The method of claim 15, wherein the real-time context-aware data comprises real-time context information relating to the vehicle, surrounding environment, and one or more individuals associated with the vehicle, wherein the one or more individuals include an owner of the vehicle, a driver of the vehicle, or one or more passengers of the vehicle, wherein the surrounding environment includes one or more of a road condition, a traffic condition, and a weather condition.

13. The method of claim 10, wherein the one or more sensors comprise one or more of a global positioning system (GPS) device, a brake sensor, a rain sensor, a fuel sensor, a temperature sensor, an oxygen sensor, a parking sensor, a compass, a speedometer, a speed sensor, a yaw rate sensor, an accelerometer, a steering wheel positioning center, a clock, a traction control system, an anti-lock brake system (ABS), an electronic stability control (ESC), an on-board diagnostics (OBD) tool, and a Bluetooth pairing device.

14. The method of claim 15, wherein the first display screen is associated with a display device coupled to an onboard computer of the vehicle or a navigation system associated with the vehicle, wherein the onboard computer includes an electronic control unit (ECU).

15. At least one machine-readable storage medium comprising a plurality of instructions that in response to being executed on a computing device, causes the computing device to carry out a method according to one or more operations comprising:
evaluating real-time context-aware data relating to a vehicle;
recommending a real-time message based the evaluation of the context-aware data, wherein the recommended message includes one or more of a warning message, an alert message, a reminder message, and an information message; and
facilitating displaying the recommended real-time message at a first display screen at the vehicle or a second display screen of a mobile computing device within a proximity of the vehicle.

16. The machine-readable storage medium of claim 15, wherein the one or more operations further comprise: receiving the real-time context-aware data from at least one of one or more sensors or devices of the vehicle, one or more computing devices in communication with the vehicle, or one or more databases.

17. The machine-readable storage medium of claim 15, wherein the one or more operations further comprise: access and mapping logic to facilitate providing access to and mapping of the evaluated real-time context-aware data over a network

18. The machine-readable storage medium of claim 15, wherein the real-time context-aware data comprises real-time context information relating to the vehicle, surrounding environment, and one or more individuals associated with the vehicle, wherein the one or more individuals include an owner of the vehicle, a driver of the vehicle, or one or more passengers of the vehicle, wherein the surrounding environment includes one or more of a road condition, a traffic condition, and a weather condition.

19. The machine-readable storage medium of claim 16, wherein the one or more sensors comprise one or more of a global positioning system (GPS) device, a brake sensor, a rain sensor, a fuel sensor, a temperature sensor, an oxygen sensor, a parking sensor, a compass, a speedometer, a speed sensor, a yaw rate sensor, an accelerometer, a steering wheel positioning center, a clock, a traction control system, an anti-lock brake system (ABS), an electronic stability control (ESC), an on-board diagnostics (OBD) tool, and a Bluetooth pairing device.

20. The machine-readable storage medium of claim 15, wherein the first display screen is associated with a display device coupled to an onboard computer of the vehicle or a navigation system associated with the vehicle, wherein the onboard computer includes an electronic control unit (ECU).
